(19) United States
(12) Patent Application Publication
(10) Pub. No.: US 2023/0093568 A1
(43) Pub. Date: Mar. 23, 2023

(54) A Continuous Type Process Method to Increase the Rate of Reaction Between Solids, Liquids, And Gasses Per Area of the Land Occupied by Two Reactors

(71) Applicant: Prakashkumar Narasimhamurthy, London (GB)

(72) Inventor: Prakashkumar Narasimhamurthy, London (GB)

(73) Assignee: Prakashkumar Narasimhamurthy, London (GB)

(21) Appl. No.: 17/909,393

(22) PCT Filed: Sep. 23, 2021
(86) PCT No.: PCT/EP2021/025106

§ 371 Date: Sep. 23, 2022

(30) Foreign Application Priority Data
Mar. 19, 2020 (GB) 2004019.2

(51) Int. Cl. B01J 8/10; B01J 8/08

(52) U.S. Cl. CPC B01J 8/10; B01J 8/085; B01J 2208/00752

(57) ABSTRACT

Two inline tower gas wet scrubbers having a moving bed of solids for scrubbing exhaust gas

Two inline tower gas wet scrubbers wherein each scrubber has a moving bed of solids 0010 that is conveyed from the top to the bottom of the towers via a plurality of perforated moving floors 003 arranged one above the other. Wherein the moving floors are mounted on plenums 004 that extend from the internal walls of the towers. A liquid 008 is sprayed from the top of each tower, wherein the liquid washes the exhaust gas, capturing particle matter and absorbing acidic gases and heat. As the liquid falls under gravity, the liquid is filtered through the solids. Exhaust gas e.g. containing CO₂ enters the first scrubber 001 above the bottom plenum and travels upwards over the moving bed towards the outlet at the top of the scrubber, whilst being washed by the falling liquid. The warm carbonated solids and liquid that exit the first reactor are fed into the top of the second reactor 002, whilst the gas exiting the first reactor enters the second reactor via the plenums/ducts that support the moving floors thereby distributing the gas throughout the reactor.

### BACKGROUND OF THE INVENTION

### Field of Invention

This invention relates to a continuous type process method in two reactors to increase the rate of reaction between solids, liquids, and gasses per area of the land occupied by the reactors from increasing the surface area interface between solids, liquids, gasses and increasing the period of exposure of solids to the liquids and gasses within the reactors per area of land occupied by the reactors when all the other conditions affecting such reactions in the reactors are constant.

### Description of the Related Art

US20050180910—discloses a process for capturing CO₂ and pollution contained in a combustion flue gas in alkaline earth metal bearing minerals. US 20110070137—discloses a number of process configurations of accelerated weathering of carbonate mineral-containing materials (AWC) reactors. U.S. Pat. No. 5,393,314 discloses a horizontal pass, multiple packed-bed gas scrubber. WO2018020005 discloses an activated carbon bed for use with a wet scrubber system. US20050084434 discloses scrubbing systems and methods for coal fired combustion units.

### SUMMARY OF THE INVENTION

The industrial application and scalability required to achieve the purpose of the mentioned prior arts and other disclosed prior arts, not mentioned here, for similar purposes will benefit from a continuous type process method which delivers increased reaction rates per area of the land occupied by the reactors when all the other conditions affecting such reactions are constant.

This implies increasing surface area interface between the solids, liquids, gasses and increasing the period of exposure of solids to liquids and gasses in reactors per area of the land occupied by the reactors. This is the main objective of the invention.

The invention is advantageous to many industrial processes to increase the chemical and physical reaction rates between solids, liquids, and gasses per area of land occupied by the reactors. An example of applying the invention to simultaneously capture the CO₂ and the pollution contained in the flue gas emission of a steel plant in the alkaline slag waste produced in a steel plant is described below.

The invention comprises two reactors of identical construction but with a small variation in the process method between the first and the second reactor. The application of two reactors overcomes the corrosion issue during the carbonation of the alkaline slag with the hot, polluted and acidic flue gas. It will improve the use of recovered thermal energy. It will increase the surface area interface between the solids, liquids, gasses with the reactors, increase the period of exposure of the solids to the liquids and gasses, and contribute to increasing the reaction rates per area of the land occupied by the first and second reactors.

The thermal energy required to enhance the reaction rates is delivered by the thermal energy contained in the hot flue gas received into the first reactor and from the heat generated from the exothermic reactions during the carbon mineralisation occurring in both the reactors.

### DESCRIPTION OF THE DRAWING

The invented continuous type process method in two reactors is illustrated in FIG. 1,

FIG. 1 illustrates a cross section of two reactors (001) and (002) without the moving bed of solids. Both reactors mainly comprise plurality of perforated horizontal moving floor (003) mounted on a plenum (004). These are arranged one above other with a space (005) in between. An opening (006) at the end of each moving floor (003) communicates with the following moving floor.

FIG. 1 also illustrates the cross section of the first reactor (001) with the moving bed of solids (010).

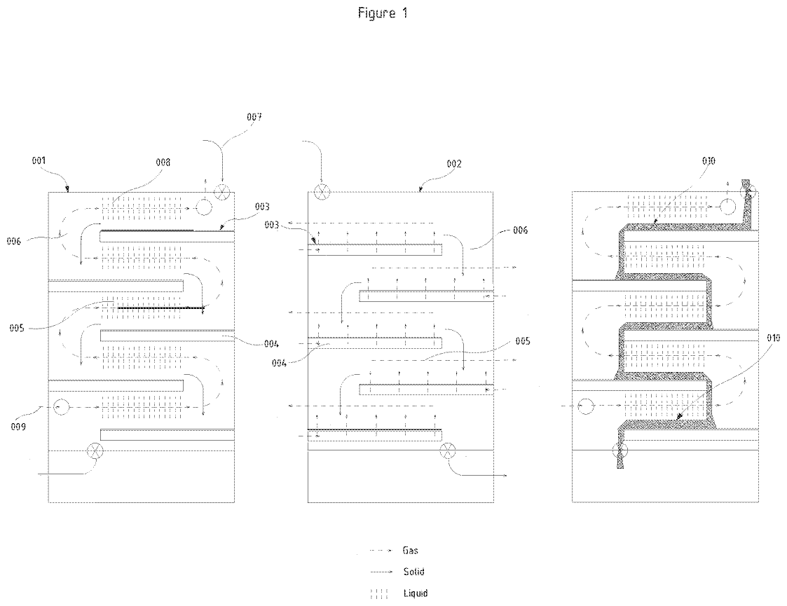

When the reactors are operational, the ambient solid alkaline slag (007) which is crushed and granulated is conveyed into the first reactor (001) and the top most moving floor receive the solids (007).

The solids form a moving bed of solids (010) and travel horizontally in a direction on the top most moving floor before it falls on to the following moving floor through the opening (006) at the end of that moving floor (003) which moves the received solids horizontally in the direction opposite to the former.

This travel pattern of solids is repeated in the following moving floors before solids exit the first reactor from the last moving floor.

Ambient liquid droplets (008) are sprayed from above evenly throughout the area of each moving bed of solids.

The diverted hot flue gasses (009) containing CO₂ and pollution before it enters the flue stack enters the first reactor (001) above the last moving bed of solids and flow counter current to the travel direction of the solids interfacing with the falling ambient liquid droplets (008).

The falling ambient liquid droplets during the interface with hot flue gasses, capture the particulate matter, absorb the acidic gasses and the heat contained in the gasses and fall evenly throughout the area of each moving bed of solids, filter through by gravitational flow to the bottom of the moving bed of solids and exit the first reactor.

The gasses get cooler, cleaner and less acidic as it travels to the top of the first reactor (001) before exiting the first reactor above the top most moving bed of solids. The surfaces in contact with the gasses are smooth, plane and corrosion resistant. The sprinklers and pipes are corrosion resistant. The moving bed of alkaline solids absorb the acidity contained in the liquid when the liquid filters through during the reaction. The solid particulates are captured as residues in the bed of solids as the liquid filters through the bed of solids. Thus, the liquid is cleaner and less acidic before it reached the perforated moving floor (003) and its parts.

The solid pollutants remain as filtered residues in the carbonized solids exiting the first reactor.

The solids and the liquids exiting the first reactor will be warmer having gained energy from the hot flue gasses and the exothermic reactions.

The exiting non corrosive, cooler and cleaner gasses from the first reactor (001) is distributed to enter into every plenum (004) in the second reactor (002).

The exiting solids from the first reactor is transferred and fed into the top of the second reactor and the top most moving perforated floor receives the solids.

The formed moving bed of solids (010) travel above all the moving floors, similar as in the first reactor, and exit the second reactor.

The gasses in the plenum are evenly distributed as updraft throughout the horizontal moving perforated floor (003), the updraft then filters through the moving bed of solids (010).

The heat energy contained in the solids increase the reaction rates.

The CO₂ reduced and cleaned flue gasses exit the surface of the moving bed of solids. The temperature of such gasses will be warmer than ambient after having gained heat from the exothermic reaction. The fine liquid particulates contained in the gasses exiting the first reactor (001) is captured in the moving bed of solids in the second reactor (002). Therefore, the warmer gasses exiting the second reactor (002) is drier than the former (001). The drier, warmer than ambient, and cleaner flue gasses exiting the second reactor (002) is safer to emit into the atmosphere than the flue gas which is currently emitted into the atmosphere in a steel plant. Thus, the existing pollution emitted from a flue stack of a steel plant can be potentially reduced to near zero level by diverting all the flue gasses into the first reactor (001).

If necessary or if found advantageous to improve the reaction rate, the warm liquid exiting the first reactor (001) is sprayed from above as droplets in the second reactor (002), as done in the first reactor (001). The updraft gasses will interface with the liquids filtering through the moving bed of solids (010) and with the falling droplets (not shown in the drawing) after the updraft exit the surface of the moving bed of solids (010).

The liquids by gravitational flow reach the bottom of the bed and exit the second reactor.

The liquids are cooled to ambient, treated, pH is neutralized, and recycled back to the first reactor (001)

The free lime normally contained in the slag waste of a steel plant restrict its use as aggregate in concrete and road construction due to the issues caused by expansion. This is one of the major reasons for slag being rejected as waste and landfilled. The free lime is stabilized into oxides in the carbonized slag exiting the second reactor making it a valuable, sustainable, and a high-quality aggregate. The pollutant residues captured in the carbonized slag does not affect the quality as it is permanently and safely locked in the used products. This is the safest and cost-effective method to dispose the solid pollutants captured from the polluted flue gasses.

The fixed packed bed of solids wet scrubbers used for pollution abatement and many other chemical processes have an inherent issue of solid matter clogging the packed bed and reducing the performance and reaction rates over a period of usage. The invention overcomes this issue as it is a moving packed bed of solids wet scrubber. The improvement in performance and the increase in reaction rates per area of land occupied by the reactors can be maintained consistently and continuously when all the other conditions affecting such reactions are constant in the reactors. This opens new opportunities to improve the quality output and reduce the cost of production in myriad existing industrial applications.

It is known from the published research papers on the CO₂ mineralization of alkaline slag^{1,2,3} that a percentage of the CO₂ contained in the flue gasses is sequestered by this route. The balance CO₂ remaining in the cleaned flue gasses can be used to enhance the photosynthesis in plants and algae grown in a protected greenhouse. Using in Carbon Capture Usage Storage (CCUS) projects will reduce the cost of cleaning and cooling the flue gasses. Thus, by integrating the invention with protected growing of plants, algae in greenhouses and CCUS projects, the existing CO₂ emission from a steel plant can be reduced to near zero level.

It is needless to emphasize that a person with reasonable skills in the related art can apply the invention to processes other than pollution abatement and mineral carbonization to achieve enhanced reaction rates between the solids, liquids and gasses.

### REFERENCES

1. Carbon Mineralization by Reaction with Steel-Making Waste: A Review; M H Ibrahim, M H El-Naas et-al—MDPI; 24 Feb. 2019
2. Electric Arc Furnace Slag as Coarse Recycled Aggregate for Concrete Production; Flora Faleschini, Katya Brunelli, Mariano Angelo, Zanini Manuele Dabala, Carlo Pellegrino, The Metals and Minerals Society October 2015
3. Investigation on the Effectiveness of Aqueous Carbonated Lime in Producing an Alternative Cementitious Material; Byung-Wan Jo, Sum it Chakraborty, Ji Sun Choi, and Jun Ho Jo: International Journal of Concrete Structures, pp 15-28 Mar. 2016

What is claimed is:

1. A continuous type process method in two reactors when operational comprise in the first reactor:
a. the solids conveyed into the top of the reactor form a moving bed on each of the plurality perforated moving floor mounted on a plenum and arranged one above the other;
b. the solids travel horizontally in a direction on the top most moving floor before it falls on to the following moving floor which moves the received solids horizontally in the direction opposite to the former;
c. this travel pattern of solids as in (b) is repeated in the following moving floors before solids exit the first reactor from the last moving floor;
d. the liquid droplets are sprayed from above evenly throughout the area of each moving bed of solids;
e. the gasses enter above the last moving bed of solids and flow counter current to the travel direction of the solids interfacing with the falling liquid droplets;
f. the droplets after the interface with the gasses fall evenly across the area of each moving bed of solids, filter through the bed by gravitational flow to the bottom of the moving bed and exit the first reactor;
g. the exiting gasses from the first reactor is distributed and enters every plenum in the second reactor;
h. the exiting solids from the first reactor is transferred and fed into the top moving perforated floor in the second reactor;
i. the solids and gasses exit the second reactor.

2. The continuous type process method in the second reactor as in claim 1 further comprise;
a. the liquid droplets are sprayed from above evenly throughout the area of each moving bed of solids;
b. the updraft gasses interface with the counter current flowing liquid inside each moving bed of solids;
c. after exiting the surface of each moving bed of solids the updraft gasses interface with the falling droplets before exiting the second reactor;
d. the liquids after reaching the bottom of the moving bed of solids will exit the second reactor.
